(19) United States
(12) Patent Application Publication
(10) Pub. No.: US 2025/0297182 A1
(43) Pub. Date: Sep. 25, 2025

(54) COLD SPRAY LOW-FRICTION SOLID LUBRICANT COATING

(71) Applicant: Applied Tungstenite Corporation, Minden, NV (US)

(72) Inventors: Eric WOODS, Minden, NV (US); Peter WOODS, Minden, NV (US); Jeffrey LINCE, Minden, NV (US)

(73) Assignee: Applied Tungstenite Corporation, Minden, NV (US)

(21) Appl. No.: 19/087,081

(22) Filed: Mar. 21, 2025

Related U.S. Application Data
(60) Provisional application No. 63/568,065, filed on Mar. 21, 2024.

(51) Int. Cl. C10M 103/06; C01G 39/06; C01G 41/00; C10M 125/04; C10M 169/04; C10N 50/08

(52) U.S. Cl. CPC C10M 103/06; C01G 39/06; C01G 41/00; C10M 125/04; C10M 169/04; C10M 2201/05; C10M 2201/0653; C10M 2201/0663; C10N 2050/08

(57) ABSTRACT

A cold spray lubricant for forming a coating includes an alloy feedstock consisting of a metal powder such as copper or nickel, and a solid lubricant, such as tungsten disulfide (WS₂) powder or molybdenum disulfide (MoS₂).

### CROSS-REFERENCE TO RELATED APPLICATIONS

This application claims priority to and the benefit of U.S. Provisional Application 63/568,065 filed on Mar. 21, 2024. The content of the above application is incorporated herein by reference in its entirety.

### STATEMENT REGARDING FEDERALLY SPONSORED RESEARCH AND DEVELOPMENT

This invention was made with government support under Contract No. 80NSSC21C0529 awarded by NASA (The National Aeronautics and Space Administration). The government has certain rights in the invention.

### FIELD

The present disclosure relates to lubricant coatings. More specifically, the present disclosure relates to low-friction solid lubricants applied by a cold spray process.

### BACKGROUND

The statements in this section merely provide background information related to the present disclosure and may not constitute prior art.

It is known in the art to apply a wear alloy to a substrate to improve its resistance wear. A wear alloy coating may be applied to a component surface by a cold spray coating process to increase the surface resistance to wear. During the coating process, particles of the coating material are directed at high speed against the surface to be coated. The coatings deform upon impact with the surface, causing them to adhere to each other and to the target surface.

Certain wear alloys are applied to components that are exposed to abrasive, harsh environments, and even in a vacuum environment. Such components include, by way of example, engine nozzles, bearings, fasteners, hydraulic fittings, and oil and gas drilling components. With this plethora of applications, the substrates are often different materials, or specialty alloys, which require special coating for proper adhesion and life. Challenges exist with developing the proper coating formulation for a specific substrate material, as well as process parameters for a coating application method such as cold spraying.

These challenges related to the application of low-friction lubricant coatings to a variety of substrates, among other challenges related to wear alloy coating processes, are addressed by the present disclosure.

### SUMMARY

This section provides a general summary of the disclosure and is not a comprehensive disclosure of its full scope or all of its features.

In one form of the present disclosure, a cold spray lubricant for forming a coating includes a mixture of a copper powder with a concentration equal to or greater than 0% by weight of the mixture, and a tungsten disulfide (WS₂) powder with a concentration between about 10% and 100% by weight of the mixture.

In variations of this cold spray lubricant, which may be implemented individually or in any combination: the copper powder has a particle size of about 1 μm; the tungsten disulfide has a particle size of about 24 μm; the coating is produced with a 20-40% powder feed rate at a temperature of about 425° C.; and the coating has a coefficient of friction between about 0.01 and 0.03 for 14000 cycles of an endurance test.

In another form of the present disclosure, a cold spray lubricant for forming a coating consists of pure tungsten disulfide (WS₂) powder. In variations of this pure tungsten disulfide (WS₂) cold spray lubricant, which may be implemented individually or in any combination: the coating is produced with a 25-100% powder feed rate tungsten disulfide (WS₂) at a temperature of about 425° C.; and the coating has a coefficient of friction of about 0.02 for 6000 cycles of an endurance test.

In still another form of the present disclosure, a cold spray lubricant for forming a coating consists of pure molybdenum disulfide (MoS₂) powder. In variations of this pure molybdenum disulfide (MoS₂) powder, which may be implemented individually or in any combination: the coating is produced with a 25% powder feed rate of molybdenum disulfide (MoS₂) at a temperature of about 370° C.; and the coating has a coefficient of friction of about 0.02-0.03 for 6000 cycles of an endurance test.

In yet another form of the present disclosure, a cold spray lubricant for forming a coating comprises a mixture of a nickel powder with a concentration equal to or greater than 0% by weight of the mixture, and a molybdenum disulfide (MoS₂) powder with a concentration between about 10% and 100% by weight of the mixture.

In variations of this cold spray lubricant, which may be implemented individually or in any combination: the nickel powder has a particle size of about 1-5 μm; the molybdenum disulfide has a particle size of about 15 μm; the coating is produced with a powder feed rate of about 25% at a temperature of about 370° C.; and the coating has a coefficient of friction of about 0.02 to 0.03 for 9000 cycles of an endurance test.

In another form of the present disclosure, a cold spray lubricant for forming a coating comprises an alloy feedstock consisting of a metal powder and a solid lubricant.

In yet another form of the present disclosure, a cold spray lubricant for forming a coating comprises an alloy feedstock consisting of a copper powder and a solid molybdenum disulfide (MoS₂) powder.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows the coefficient of friction obtained using a pin-on-disk tribometer with a 2N normal load for a coating produced with a nominal content of 1 μm Cu mixed with 20 wt. % of 24 μm WS₂ at a powder feed rate of 20% and a gas temperature of 425° C. in accordance with the teachings of the present disclosure;

FIG. 2 shows the coefficient of friction obtained using a 2N normal load for a coating produced with a nominal content of 1 μm Cu mixed with 20 wt. % of 24 μm WS₂ at a powder feed rate of 30% and a gas temperature of 425° C. in accordance with the teachings of the present disclosure;

FIG. 3 shows the coefficient of friction obtained using a 2N normal load for a coating produced with pure 0.58 μm WS₂ at a powder feed rate of 100% and a gas temperature of 425° C. in accordance with the teachings of the present disclosure;

FIG. 4 shows the coefficient of friction obtained using a 2N normal load for a coating produced with pure 0.58 μm WS₂ at a powder feed rate of 100% and a gas temperature of 200° C. in accordance with the teachings of the present disclosure;

FIG. 5 shows a table of comparisons between nominal sulfide content in the feedstock to actual sulfide content in the coating;

FIG. 6 shows an EDX map obtained using an SEM of a cross section produced by focused ion beam (FIB) technology of a coating made from a nominal mixture of 1 μm Cu with 80 wt. % of 24 μm WS₂, with one location shown on the left and another location on the right;

FIG. 7 shows an SEM image and EDX Maps of a FIB cross section of a coating made from a nominal mixture of 1 μm Cu with 90 wt. % of 24 μm WS₂;

FIG. 8 shows an EDX Map of a metallurgical cross section of a coating made from 0.58 μm diam WS₂ on SS, without any metal addition, with the green color representing S from WS₂;

FIG. 9 is a graph illustrating the coefficient of friction over a number of cycles for feedstock having different percentages of WS₂;

FIG. 10 is another graph illustrating the coefficient of friction over a number of cycles obtained using a 2N normal load for feedstock having 90 wt. % WS₂;

FIG. 11 is a graph illustrating the coefficient of friction over a number of cycles obtained using a 10N normal load for feedstock having Cu and 90 wt. % MoS₂;

FIG. 12 is a graph illustrating the coefficient of friction over a number of cycles obtained using a 10N normal load for feedstock having Ni and 80 wt. % MoS₂;

FIG. 13 is a graph illustrating the coefficient of friction over a number of cycles obtained using a 10N normal load for feedstock having Ni and 88 wt. % WS₂;

FIG. 14 is a graph illustrating the coefficient of friction over a number of cycles obtained using a 10N normal load for feedstock with pure WS₂; and

FIG. 15 is a graph illustrating the coefficient of friction over a number of cycles obtained using a 10N normal load for feedstock with pure MoS₂.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The inventors have discovered design factors of a cold spray lubricant coating to reduce the coefficient of friction of the coating. As used herein, the term “cold spray” should be construed to mean a process in which solid powder particles (in the diameter ranges set forth below in μm) are accelerated in a supersonic gas jet to high velocities. During impact with a substrate, the solid powder particles undergo plastic deformation and adhere to the surface of the substrate. Cold spray process temperatures can range between about 0° C. to about 1100° C.

Generally, the present disclosure includes an alloy feedstock consisting of a metal powder, such as copper or nickel, and a solid lubricant, such as tungsten disulfide (WS₂) powder or molybdenum disulfide (MoS₂). Pure WS₂ powder and pure MoS₂ were also evaluated as set forth in greater detail below.

In one form, a lubricant mixture with 1.4 wt. % WS₂ (tungsten disulfide, 5 μm) mixed with Cu powder (11-38 μm) showed lower friction and wear than a control 316 SS (stainless steel) sample, but the coefficient of friction (COF) was poor (generally >0.3), and the endurance was poor, with failure generally occurring after only a few hundred cycles. In addition, the small amount of WS₂ kept the Cu powder from building up to a significant thickness on the substrate.

In other variations, a smaller metal particle size (1 μm) was paired with a larger WS₂ particle size (24 μm). Larger WS₂ contents also appear to be more promising, and thus these particle sizes were used with a Cu/20 wt. % WS₂ mixture. The performance was highly dependent on both the N₂ gas temperature and powder feed rate. (The feed rates are presented in arbitrary units of percent, with 100% being the maximum capacity of the powder feeder unit; actual units in terms of mass flow per second were not determined).

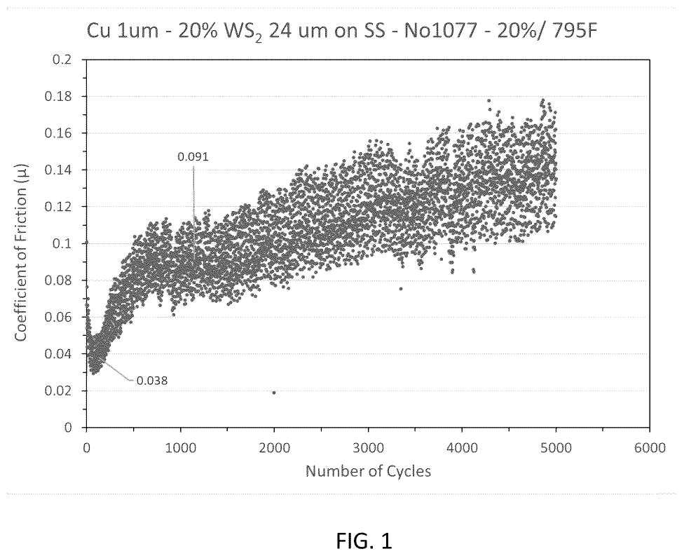

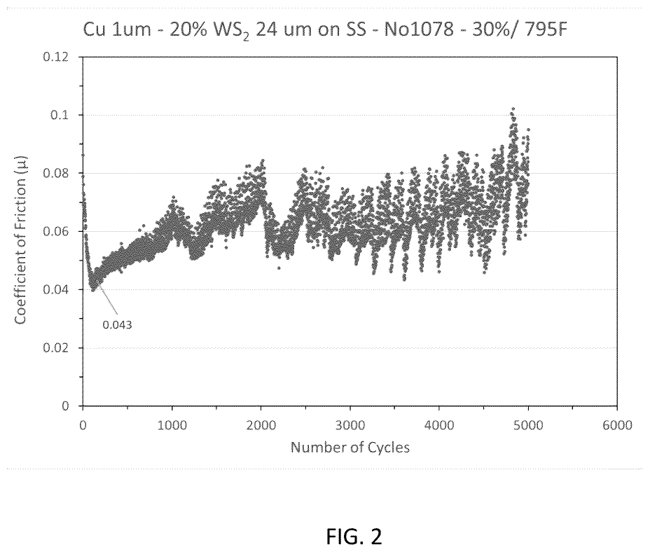

For example, FIG. 1 shows tribometry results obtained at a 2N normal load for a Cu/20 wt % WS₂ coating produced using a 20% powder feed rate, while FIG. 2 shows corresponding results for a coating produced with all the same parameters, except for using a 30% powder feed rate. Although both coatings showed good performance—with relatively low friction and endurance ≥5000 cycles—the coating with the 30% feed rate showed significantly lower friction (i.e., COF≤0.10).

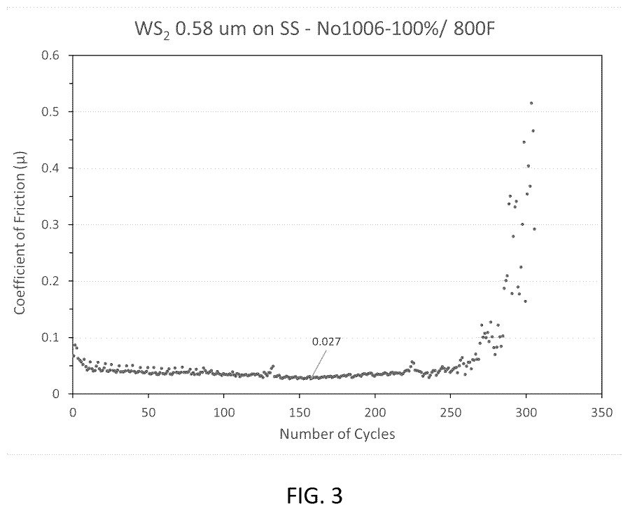

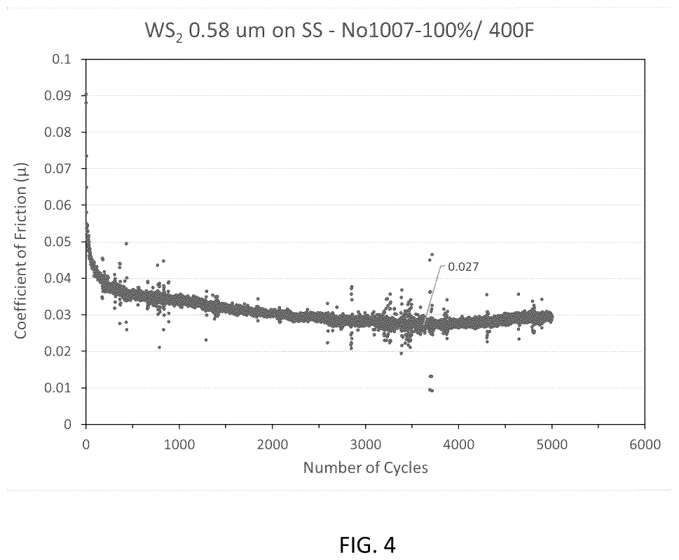

Since increased WS₂ contents in composite coatings appeared promising, pure WS₂ cold spray coatings were tested. Again, performance was highly dependent on both the N₂ gas temperature and powder feed rate. FIG. 3 shows tribometry results obtained at a 2N normal load for a pure 0.58 μm particle size WS₂ powder, produced using a gas temperature of 425° C. FIG. 4 shows corresponding results for a coating produced with all the same parameters, except using a gas temperature of 204° C. Although both coatings showed good friction (i.e., COF≤0.10), the coating produced at the lower temperature showed greatly increased endurance (>5000 cycles as opposed to only 300 cycles). (As shown below, different temperature dependence was seen for different WS₂ particle sizes and feed rates)

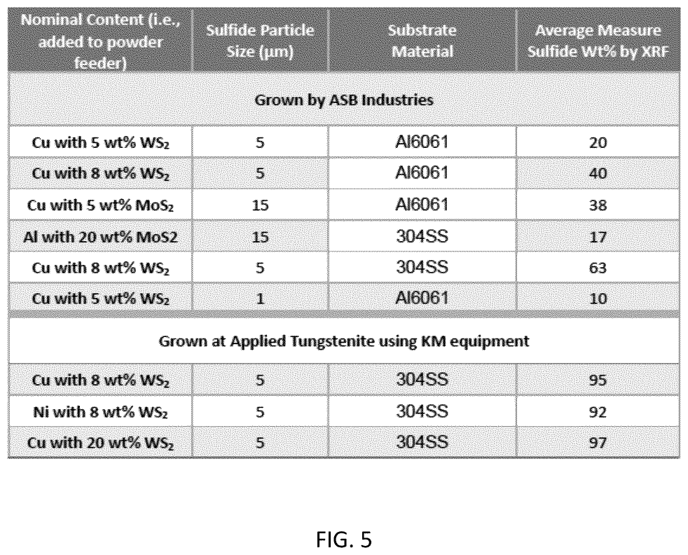

X-ray Fluorescence (XRF) spectrometry was utilized for understanding the cold spray process in that it enables correlating the coating composition with deposition parameters and ultimately performance. It has also shown that the nominal metal:solid lubricant powder ratio added to the powder feeder is markedly different from the actual composition of the coating. FIG. 5 shows a comparison of nominal to actual sulfide (i.e., WS₂ or MoS₂) content in the coatings.

Data showed that sulfide particle size affects the sulfide content in the coatings, as does the type of co-deposited metal (i.e., Cu vs Ni vs Al). The type of cold spray equipment also has an effect on the composition of the coatings. Specifically, coatings on one piece of equipment have extremely high sulfide content (i.e., >90 wt %), compared to the coatings with other equipment (i.e., 10-63 wt %).

The particle size of the metallic powders was shown to have an impact on coating performance. The tests demonstrated improved coating performance by reducing the size of the Cu particles and enlarging the size of the WS₂ particles. However, smaller powder size has a tendency to clog in the equipment. Therefore, the powder should be large enough to flow through the machine but small enough to create a strong composite dry film lubricant. Thus, further forms of the present disclosure include Cu powder size of 5 μm and other formulations, including the use of other metallic powders and MoS₂.

Another important parameter is coating thickness and uniformity, which relates directly to both friction and endurance. Cross-sections of some of the coatings obtained using focused ion beam (FIB) technology were analyzed using Scanning Electron Microscopy equipped with Energy Dispersive X-ray analysis (SEM/EDX). The coating substrate interface can be difficult to analyze by SEM alone, but EDX can be used to give elemental maps that show the distribution of coating materials that more clearly show thickness and uniformity of the coatings.

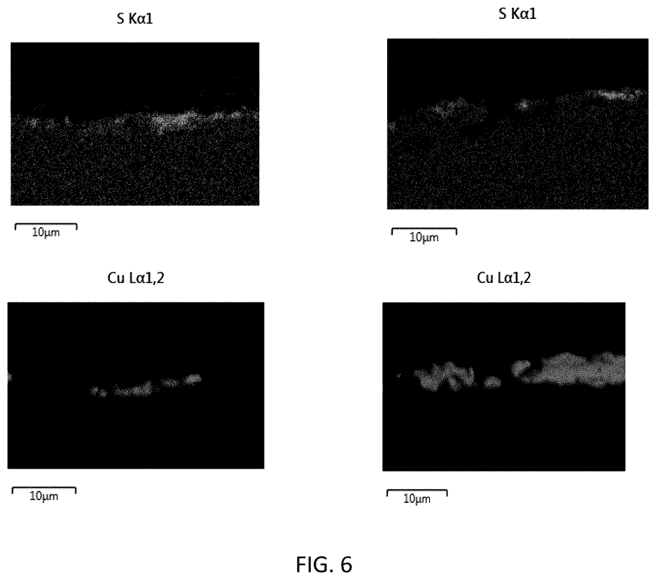

FIG. 6 shows elemental maps of S (from WS₂ solid lubricant) and Cu in a WS₂ coating (#1078; nominal composition 1 μm Cu with 20 wt. % of 24 μm WS₂; friction trace shown in FIG. 2). The green represents S (from WS₂), and the blue represents Cu. Two locations at the coating/substrate interface are shown. The overall coating is fairly uniform, but the individual WS₂ and Cu species within the coating are not. Specifically, the WS₂ forms patches, in between which are patches of Cu.

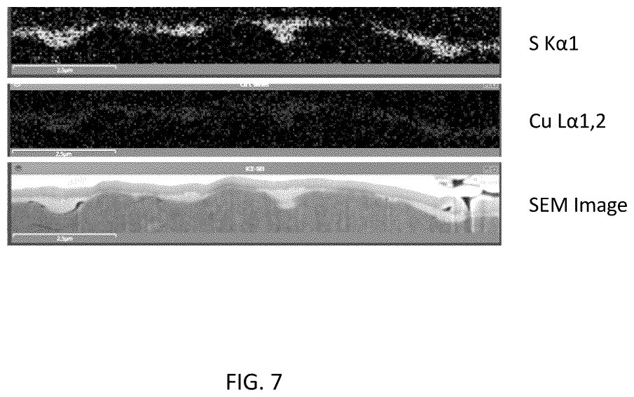

FIG. 7 shows elemental maps of S (from WS₂ solid lubricant) and Cu in another WS₂ coating (#2102; nominal composition 1 μm Cu with 9 wt. % of 24 μm WS₂). The yellow color represents S from WS₂, and the red represents Cu. In contrast to the coating with higher Cu content (see FIG. 6), the Cu is interspersed relatively evenly throughout the WS₂ layer.

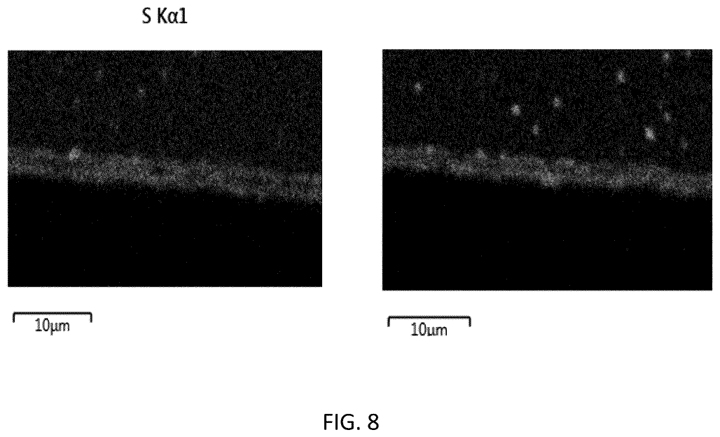

FIG. 8 shows elemental maps of S (from WS₂ solid lubricant) for a pure WS₂ coating (#1007; 0.58 μm diameter WS₂). Again, two locations at the coating/substrate interface are shown. In this case WS₂ forms a uniform coating.

The friction of the pure WS₂ coating exhibits lower and more constant friction compared to the Cu/WS₂ coating. This is likely due to the higher uniformity of the pure WS₂ coating. The relatively small thickness of these coatings (<0.0002 inch) is important for certain tolerance-sensitive applications, for example, in ball bearing applications.

As discussed above, X-ray Fluorescence (XRF) spectrometry was used to understand the cold spray process and to correlate the coating composition with deposition parameters and ultimately performance. For example, the nominal metal:solid lubricant powder ratio added to the powder feeder is markedly different from the actual composition (see FIG. 5) of the coating. In addition, the metal:solid lubricant ratio appears to be a strong function of the particle size in the coatings as well as the powder feed rate. The tribological performance is a function of all of these variables.

Further variations of the present disclosure include Cu/WS₂ coatings using 24 μm WS₂ mixed with 1 μm, 5 μm, or 10 μm Cu powders. In addition, the WS₂ content of the Cu/WS₂ coatings may be increased.

Also, additional metals to mix with WS₂, including Ni and alloys such as NiTi are contemplated by the teachings herein. As indicated above, WS₂ may be replaced with MoS₂, since MoS₂ often outperforms WS₂ in many solid lubricant formulations, and further it is more widely used in the spacecraft industry.

In one variation of the present disclosure, the cold spray coating includes MoS₂ without additives in the powder feeder and has particle sizes between 100 nm to 24 μm. In this form, the gas temperature is between 40° C.-800° C. and the feeder gas is Nitrogen. In another variation, the feeder gas is Helium.

In another form, the cold spray coating includes WS₂ without additives in the powder feeder with particle sizes between 1 μm to 70 μm. The gas temperature is between 40° C.-800° C. The feeder may be Nitrogen or Helium.

In another form, the cold spray coatings include a mixture of a metal with either the MoS₂, with a particle size between 100 nm to 24 μm, or WS₂, with a particle size between 100 nm to 70 μm, to form a composite metal lubricant coating. Similarly, feeder gas may be Nitrogen or Helium. Further, the gas temperature is between 40° C.-800° C. The metal species used in the cold spray coating mixture is either a pure element or an alloy including at least one of nickel, copper, titanium, aluminum, silver, tin, brass, bronze, indium, steel, titanium alloy Ti6Al4V, aluminum alloy Al6061, and other similar elements or alloys. In one variation, the metal is a copper alloy and has a particle size between 40 nm to 38 μm. In another variation, the metal is a nickel alloy and has a particle size between 200 nm to 45 μm. In yet another variation, the composition in the powder feeder is greater than 0 and up to 80 wt. % mixed metal.

In one aspect, the cold spray coating includes WS₂ without additives, wherein the WS₂ has a particle size of 100 nm. In another form, the WS₂ has a particle size of 0.58 μm. For both aforementioned particle sizes, Nitrogen carrier gas is used at 370° C. In another form, MoS₂ with a particle size of 15 μm is employed without additives, which is used in the powder feeder for the cold spray coatings with a Nitrogen carrier gas at 370° C.

In yet another form, the powder mixture in the powder feeder is a mixture of 1 μm particle size Copper with 90% wt. % of 100 nm particle size WS₂ with a Nitrogen carrier gas at 425° C. In another variation, the powder feeder mixture is a mixture of 1 μm particle size Copper with 90% wt. % of 15 μm particle size WS₂ with a Nitrogen carrier gas at 370° C. In yet another variation, the cold spray coating powder feeder mixture is a mixture of 5 μm particle size Nickel with 80% wt. % of 15 μm particle size MoS₂ with a Nitrogen carrier gas at 425° C.

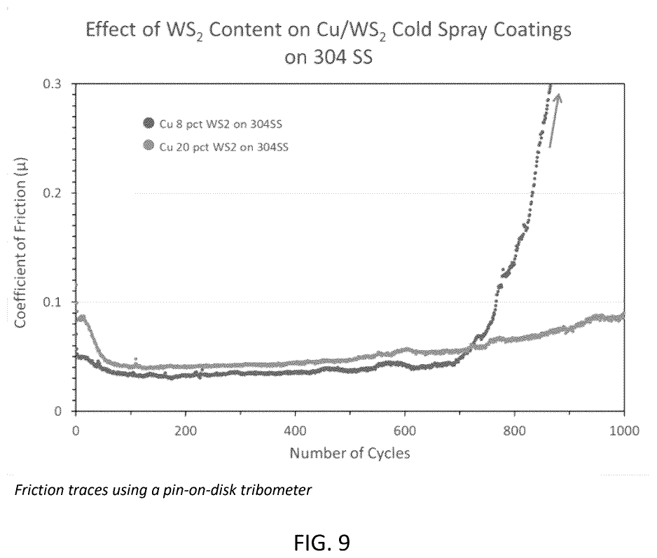

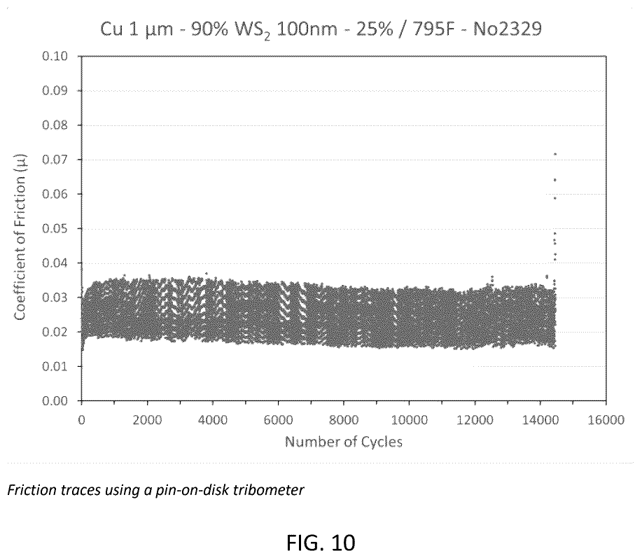

Referring to FIGS. 9-10, additional tribometer testing was conducted to determine optimum ratios of metal-to-metal sulfide (solid lubricant) to produce improved friction/wear properties. As shown in FIG. 9, testing was conducted on two different Cu/WS₂ feedstocks, one with 8 wt. % WS₂ and the other with 20 wt. % WS₂, which were applied to a 304 stainless steel substrate. Testing was conducted with a normal load of 2N. Both feedstocks demonstrated low coefficient of friction values up to about 700 cycles, with the 20 wt. % WS₂ feedstock demonstrating better performance over higher cycles.

Further testing shown in FIG. 10 demonstrated that even higher amounts of WS₂, up to 90 wt. %, had even lower coefficients of friction and higher endurance (number of cycles). (Normal load was increased to 10N here and results presented below)

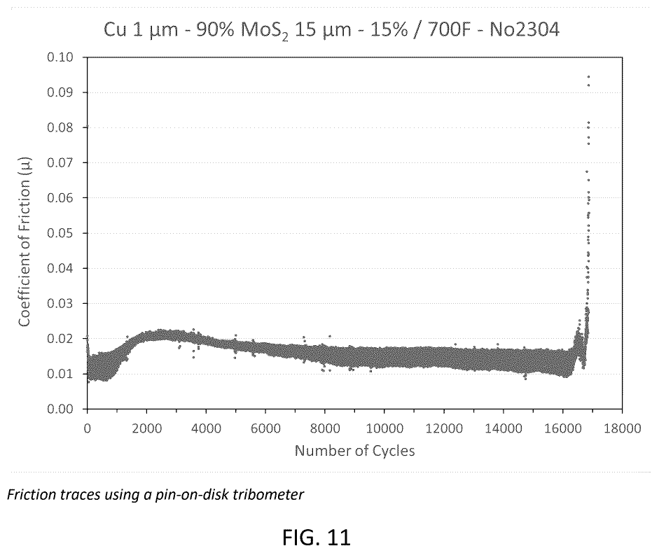

FIG. 11 shows test results for a Cu/MoS₂ coating having 90 wt. % MoS₂. This particular coating demonstrated excellent performance up to about 17,000 cycles and an average COF of about 0.015.

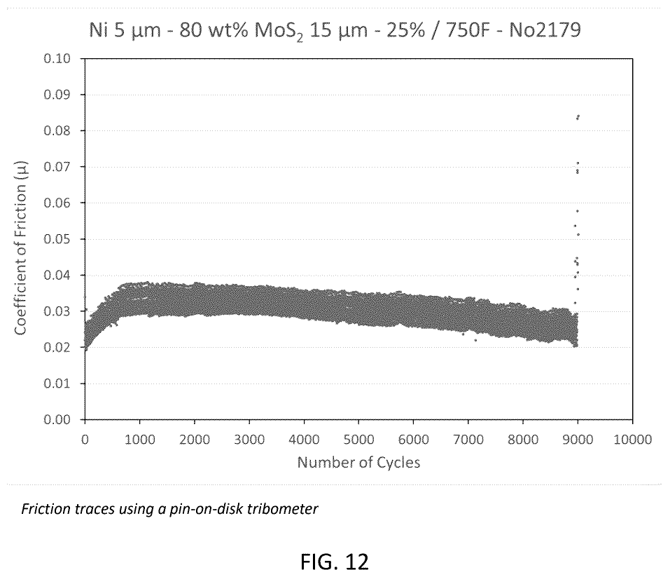

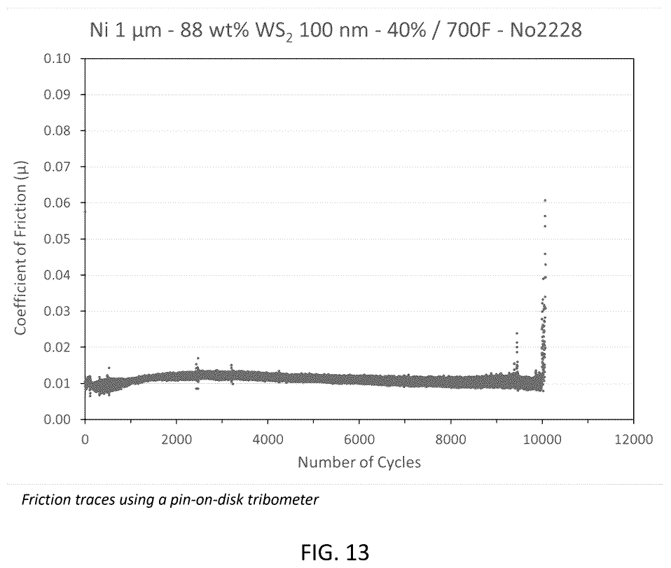

Referring to FIGS. 12-13, additional testing at 10N normal load was conducted with Ni rather than Cu. FIG. 12 shows results with feedstock containing 80 wt. % MoS₂, and FIG. 13 shows results with feedstock containing 88 wt. % WS₂. The average endurance/cycles for both coatings, as well as average COF was improved versus pure MoS₂ or pure WS₂, however not as good as results with Cu.

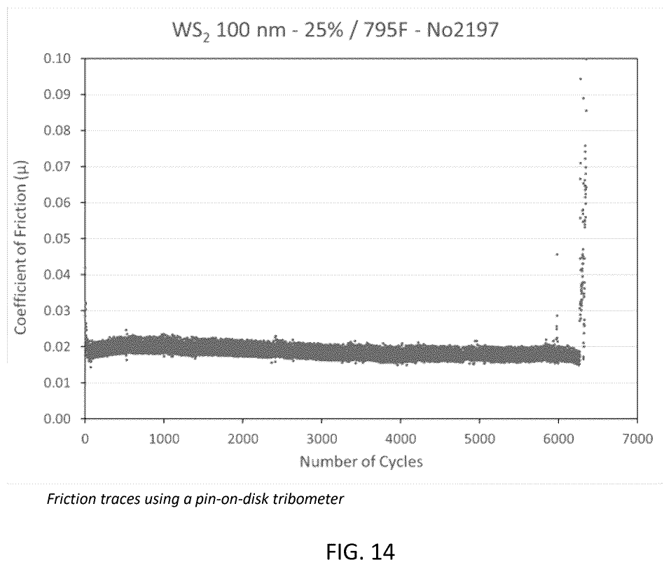

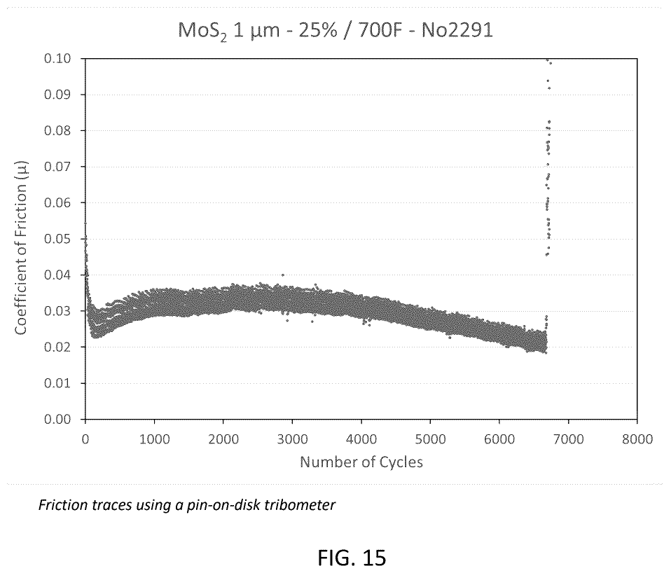

Because these test results demonstrated improved performance (i.e., lower COF and higher endurance) with lower amounts of Cu and Ni, further testing was conducted on pure WS₂ and MoS₂, also at 10N normal load. FIG. 14 shows the results for a pure WS₂ coating using 100 nm particles, while FIG. 15 shows the results for a pure MoS₂ coating using 1 μm particles. Both these pure coatings demonstrated excellent results with low COF, although with somewhat lower endurance than the coatings containing Cu or Ni, indicating that some amount of metal addition is beneficial to overall performance.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A cold spray lubricant for forming a coating, the lubricant comprising:
a mixture of:
a copper powder with a concentration equal to or greater than 0% by weight of the mixture; and
a tungsten disulfide (WS₂) powder with a concentration between about 10% and 100% by weight of the mixture.

2. The cold spray lubricant of claim 1, wherein the copper powder has a particle size of about 1 μm.

3. The cold spray lubricant of claim 1, wherein the tungsten disulfide has a particle size of about 24 μm.

4. The cold spray lubricant of claim 1, wherein the coating is produced with a 20-40% powder feed rate at a temperature of about 425° C.

5. The cold spray lubricant of claim 4, wherein the coating has a coefficient of friction between about 0.01 and 0.03 for 14000 cycles of an endurance test.

6. A cold spray lubricant for forming a coating, the lubricant consisting of pure tungsten disulfide (WS₂) powder.

7. The cold spray lubricant of claim 6, wherein the coating is produced with a 25-100% powder feed rate tungsten disulfide (WS₂) at a temperature of about 425° C.

8. The cold spray lubricant of claim 7, wherein the coating has a coefficient of friction of about 0.02 for 6000 cycles of an endurance test.

9. A cold spray lubricant for forming a coating, the lubricant consisting of pure molybdenum disulfide (MoS₂) powder.

10. The cold spray lubricant of claim 9, wherein the coating is produced with a 25% powder feed rate of molybdenum disulfide (MoS₂) at a temperature of about 370° C.

11. The cold spray lubricant of claim 9, wherein the coating has a coefficient of friction of about 0.02-0.03 for 6000 cycles of an endurance test.

12. A cold spray lubricant for forming a coating, the lubricant comprising:
a mixture of:
a nickel powder with a concentration equal to or greater than 0% by weight of the mixture; and
a molybdenum disulfide (MoS₂) powder with a concentration between about 10% and 100% by weight of the mixture.

13. The cold spray lubricant of claim 12, wherein the nickel powder has a particle size of about 1-5 μm.

14. The cold spray lubricant of claim 12, wherein the molybdenum disulfide has a particle size of about 15 μm.

15. The cold spray lubricant of claim 12, wherein the coating is produced with a powder feed rate of about 25% at a temperature of about 370° C.

16. The cold spray lubricant of claim 15, wherein the coating has a coefficient of friction of about 0.02 to 0.03 for 9000 cycles of an endurance test.

17. A cold spray lubricant for forming a coating, the lubricant comprising:
a mixture of:
a nickel powder with a concentration equal to or greater than 0% by weight of the mixture; and
a tungsten disulfide (WS₂) powder with a concentration between about 10% and 100% by weight of the mixture.

18. The cold spray lubricant of claim 17, wherein the nickel powder has a particle size of about 1-5 μm.

19. The cold spray lubricant of claim 17, wherein the tungsten disulfide has a particle size of about 100 nm.

20. The cold spray lubricant of claim 17, wherein the coating is produced with a powder feed rate of about 40% at a temperature of about 370° C.

21. The cold spray lubricant of claim 20, wherein the coating has a coefficient of friction of about 0.01 for 10000 cycles of an endurance test.

22. A cold spray lubricant for forming a coating, the cold spray lubricant comprising:
an alloy feedstock consisting of:
a metal powder; and
a solid lubricant.

23. A cold spray lubricant for forming a coating, the cold spray lubricant comprising:
an alloy feedstock consisting of:
a copper powder; and
a solid molybdenum disulfide (MoS₂) powder with a concentration between about 10% and 100% by weight.

24. The cold spray lubricant of claim 23, wherein the copper powder has a particle size of about 1 μm.

25. The cold spray lubricant of claim 23, wherein the molybdenum disulfide has a particle size of about 15 μm.

26. The cold spray lubricant of claim 23, wherein the coating is produced with a 15-25% powder feed rate at a temperature of about 370° C.

27. The cold spray lubricant of claim 26, wherein the coating has a coefficient of friction between about 0.01 and 0.02 for 17000 cycles of an endurance test.
